(19) United States
(12) Patent Application Publication
(10) Pub. No.: US 2025/0060743 A1
(43) Pub. Date: Feb. 20, 2025

(54) REMOTE EQUIPMENT MONITORING AND MANAGEMENT SYSTEM

(71) Applicant: Cornell Pump Company LLC, Clackamas, OR (US)

(72) Inventors: William James Warren, Boring, OR (US); Zachary Thomas, Portland, OR (US); Kenneth Willard, Portland, OR (US); Adam Lindeman, Oregon City, OR (US); James Andrew Enterline, Troutdale, OR (US)

(21) Appl. No.: 18/804,581

(22) Filed: Aug. 14, 2024

Related U.S. Application Data
(60) Provisional application No. 63/519,867, filed on Aug. 16, 2023.

(51) Int. Cl. G05B 23/02

(52) U.S. Cl. CPC G05B 23/0283; G05B 2223/06

(57) ABSTRACT

A device, system, and methods are provided for remotely monitoring and managing pump equipment. One or more monitoring devices are configured to provide operational data and geolocation data of monitored equipment. A network device is configured to receive monitoring data from the monitoring devices via different device-specific APIs, perform a data transformation to standardize the monitoring data into standardized data, and store the standardized data in a database. The network device further provides to a user device a user interface to select an asset group of the monitored equipment and receives, from the user device via the user interface, a definition of the asset group. The network device monitors the monitored equipment of the asset group based on the operational data and geolocation data, and provides information to the user device based on the monitoring.

### CROSS-REFERENCE TO RELATED APPLICATION

This application claims priority under 35 U.S.C. § 119, based on U.S. Provisional Patent Application No. 63/519,867 filed Aug. 16, 2023, titled “Remote Equipment Monitoring and Management System,” the disclosure of which is hereby incorporated by reference.

### BACKGROUND OF THE INVENTION

Remote monitoring and management of industrial equipment, such as commercial pumps, can be beneficial for numerous industries, such as mining, agriculture, refrigeration, food processing, and other industries. Common tasks, such as monitoring equipment health, diagnosing failures, scheduling repairs or preventative maintenance, and allocating resources, may be simplified with remote capabilities and reduce manhours dedicated to such efforts. However, even when systems to support tasks are available, current systems address only partial capabilities with respect to the overall set of monitoring and management tasks.

### BRIEF DESCRIPTION OF THE DRAWINGS

FIG. 1 is a diagram of an example environment in which systems and methods described here may be implemented;

FIG. 2 is a diagram illustrating functional components and communications of an application network of FIG. 1;

FIG. 3 is a diagram illustrating example functional components of a client application programming interface (API) of FIG. 2;

FIG. 4A is a block diagram of example logical components of a location management module of FIG. 3;

FIGS. 4B-4D are example screen shots illustrating functions of the location management module, according to an implementation;

FIG. 5A is a block diagram of example logical components of an asset grouping tool of FIG. 3.

FIG. 5B is an example screen shot illustrating functions of the asset grouping tool, according to an implementation;

FIG. 6 is an example screen shot illustrating a user interface for generating a maintenance log;

FIG. 7 is a block diagram of internal components of the monitoring device of FIG. 1, according to an implementation;

FIG. 8 is a flow diagram of a process for an equipment monitoring and management system, according to an exemplary implementation; and

FIG. 9 is a block diagram illustrating components of a network device or user device.

### DETAILED DESCRIPTION

The following detailed description refers to the accompanying drawings. The same reference numbers in different drawings may identify the same or similar elements. Also, the following detailed description does not limit the invention.

Systems and methods described herein provide an equipment monitoring system that connects pumps, pump-related assets, and end-users in an asset-management system. Field equipment may be equipped with monitoring devices that collect operational and location data for the monitored field equipment. The monitoring devices may be configured to collect data in a variety of different formats and standards, standardize the collected data, and store the standardized data for access by users. The systems and methods described herein tie together different field equipment (e.g., pumps and pump-related equipment, monitoring devices, internal sensors, and other peripherals), collectively referred to herein as “assets,” into a single system.

The systems and methods may enable authorized sellers (e.g., original equipment manufacturers, distributors, etc.) post-sale visibility of their assets. If a monitoring device has been installed on field equipment (e.g., a pump), algorithms can be enabled to remotely improve the performance of the field equipment. Assets may be managed by groupings, which may be based on locations, ownership, lease/rental groups, departments, etc. In one implementation, the systems and methods may store recommended service schedules and monitor field equipment for service times and/or other operational parameters. In other implementations, the systems and methods may store operational thresholds (e.g., rotational speeds, temperatures, vibration, displacement, etc.) and monitor field equipment for indications of exceeding the operational thresholds. The systems and methods may provide alerts based on monitored locations (e.g., geofencing) and equipment health. The systems and methods may also allow for managing of permissions to control which end-users, retailers, owners, or sellers can have visibility and/or control of grouped assets.

Conventional pump monitoring systems are typically isolated and/or siloed. Data from one monitoring system may not be compatible with formatted data from a different monitoring system. Furthermore, data available to the end user may not be readily available to service technicians or manufacturers for trouble shooting. Furthermore, secondary customers (e.g., users of rental equipment) may be unaware of service requirements or operating limits for field equipment.

According to an implementation, a system may include one or more monitoring devices and a network device. The monitoring devices may be configured to provide, on a periodic basis, operational data and geolocation data of the monitored equipment. For example, the monitoring devices may provide data for rotational speeds, temperatures, vibration, displacement, etc., of monitored equipment. The network device may be configured to receive monitoring data from the monitoring devices via different device-specific application programming interfaces (APIs,) perform a data transformation to standardize the monitoring data into standardized data, and populate the standardized data in a database. The network device may also provide, to a user device, a user interface to select an asset group of monitored devices and receive from the user device a definition of the asset group. For example, an asset group may be defined based on a geographic area defined by a user of the user device. The network device may monitor the monitored equipment of the asset group based on the operational data and location data (also referred to herein as geolocation data) and provide status updates to the user device.

According to other implementations, the network device may be further configured to store, in the database, operating thresholds and maintenance schedules for different equipment models of the asset group and associate each of the monitored equipment of the asset group with the operating thresholds and maintenance schedules of one of the different equipment models. The instructions for monitoring the monitored equipment may further include identifying when any monitored equipment of the asset group achieves an operational parameter that exceeds a corresponding operating threshold, or identifying when any monitored equipment of the asset group reaches a service hour threshold associated with a corresponding maintenance schedule.

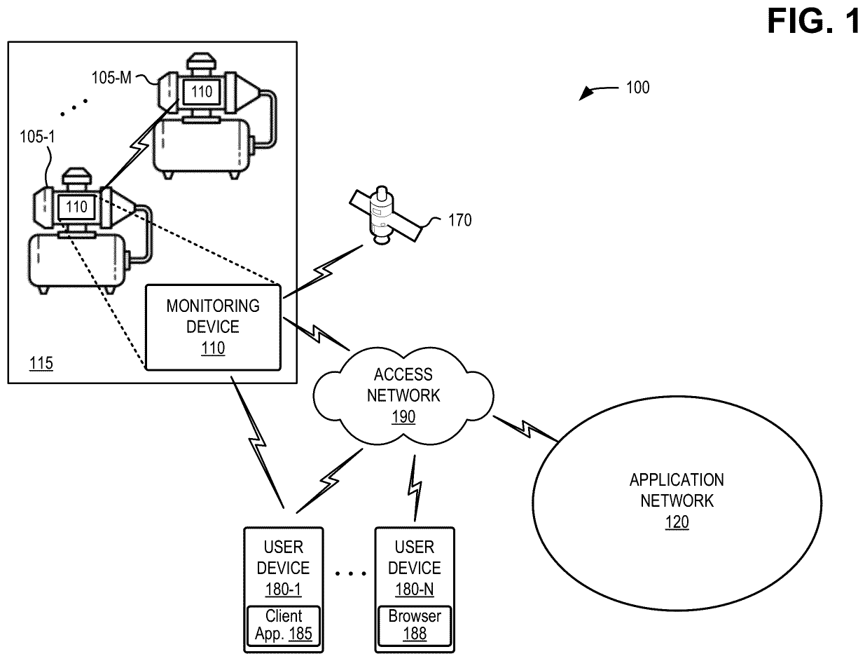

FIG. 1 is a diagram illustrating an exemplary environment 100 in which systems and/or methods described herein may be implemented. As illustrated, environment 100 may include pump equipment 105-1 through 105-M (collectively and individually referred to herein as “pump equipment 105”). Each of pump equipment 105 may include a mounted monitoring device 110 (collectively referred to herein as “monitoring devices 110” and individually as “monitoring device 110”). Monitoring devices 110 may include one or multiple different types. Environment 100 may also include an application network 120, a global positioning system (GPS) 170, and user devices 180-1 through 180-N (collectively referred to herein as “user devices 180” and individually as “user device 180”) interconnected by access network 190. Different components of environment 100 may be connected via wired and/or wireless links.

Pump equipment 105 may include a pump, engine, electric motor, or any other piece of equipment (e.g., rotating equipment) of which a user wishes to monitor one or more operational parameters. Pump equipment 105 may be distributed throughout a customer premises 115, such as industrial, commercial, educational, agricultural customer premises, etc.

Monitoring device 110 may include an Internet of Things (IoT) device, a Machine Type Communication (MTC) device, a machine-to-machine (M2M) device, an enhanced MTC device (eMTC) (also known as Cat-M1), an end node employing Low Power Wide Area (LPWA) technology such as Narrow Band (NB) IoT (NB-IoT) technology, or some other type of wireless end node. Monitoring device 110 may include, for example, a vibration sensor, a temperature sensor, a location monitor, a communications module, a sensor interface, and a power supply. According to various exemplary embodiments, monitoring device 110 may include hardware, such as a processor, application-specific integrated circuit (ASIC), a field-programmable gate array (FPGA), or a combination of hardware and software (e.g., a processor executing software) to execute various types of functions described further herein. As described further herein, monitoring device 110 may be attached to pump equipment 105; collect vibration, temperature, location, and other data for pump equipment 105; and forward the collected data to application network 120 for access by users of user devices 180.

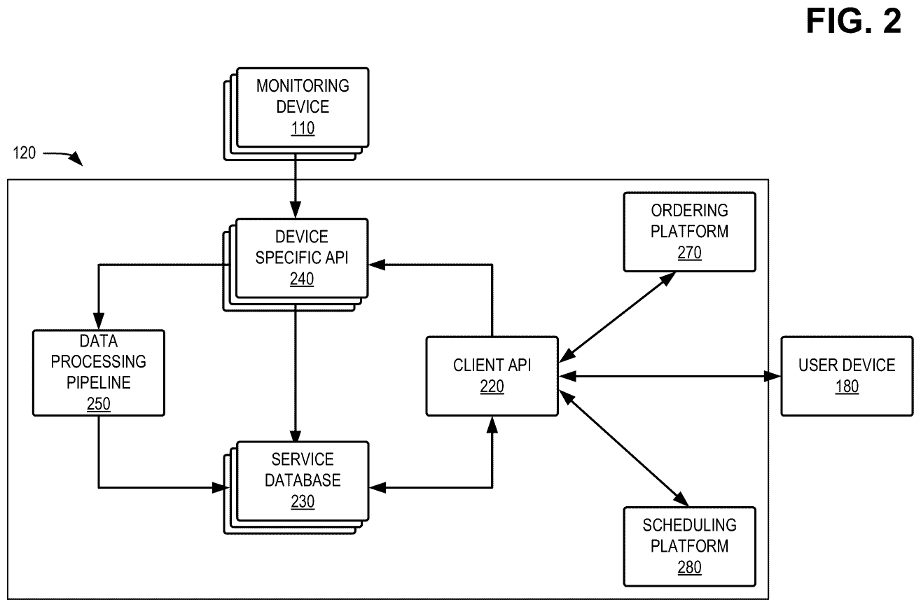

Application network 120 may include network devices, computing devices, and other equipment to provide services, including services for customers with monitoring devices 110. For example, devices in application network 120 may supply backend services for monitoring devices 110 and user devices 180 to remotely monitor pump equipment 105. Application network 120 may include, for example, one or more private Internet Protocol (IP) networks that use a private IP address space. Application network 120 may include a local area network (LAN), an intranet, a private wide area network (WAN), etc. According to an implementation, application network 120 may use vendor-specific protocols to support IoT management. In another implementation, application network 120 may include a hosting platform that provides a data management service. The data management service may include receiving data packets that are transmitted by monitoring devices 110 and implementing models to collect, store, analyze, and/or present data from monitoring devices 110. Examples of hosting platforms that may use different protocols and commands include Amazon® Web Services (AWS), Microsoft Azure®, IBM Watson®, Verizon® ThingSpace®, etc. Although shown as a single element in FIG. 1, application network 120 may include a number of separate networks. Aspects of application network 120 are described further in connection with, for example, FIG. 2.

Global positioning system 170 may include one or more devices configured to provide location information to monitoring devices 110. In some implementations, location information may include, for example, GPS information or another form of global navigation satellite system (GNSS) information. In one implementation, positioning system 170 may include one or more cellular towers, wherein user devices may retrieve location information in the form of cellular tower triangulation information. Additionally, or alternatively, positioning system 170 may include a GPS satellite to determine a location of monitoring device 110.

User device 180 includes a device that has computational and wireless communication capabilities. User device 180 may be implemented as a mobile device, a portable device, a stationary device, a device operated by a user, or a device not operated by a user. For example, user device 180 may be implemented as a smartphone, a computer, a tablet, a wearable device, or some other type of wireless device. According to various exemplary embodiments, user device 180 may be configured to execute various types of software (e.g., applications, programs, etc.). As described further herein, user device 180 may download and/or register a client application 185. As described further herein, the client application 185 (or “app”) may be designed to access, from application network 120, data reported by monitoring devices 110. In another implementation, user device 180 may use a web browser 188 to access application network 120 and perform similar functions of client application 185. User device 180 may be associated with a customer/end user of field equipment (e.g., equipment 105), a retailer, an OEM, etc.

Network 190 may include one or more wired, wireless and/or optical networks that are capable of receiving and transmitting data, voice and/or video signals. For example, network 190 may include one or more access networks, IP multimedia subsystem (IMS) networks, core networks, or other networks. The access network may include one or more wireless networks and may include a number of transmission towers for receiving wireless signals and forwarding wireless signals toward the intended destinations. The access network may include a wireless communications network that connects subscribers (e.g., monitoring devices 110, user devices 180, etc.) to other portions of network 190 (e.g., the core network). In one example, the access network 190 may include a long-term evolution (LTE) network. In other implementations, the access network 190 may employ other cellular broadband network standards such as 3rd Generation Partnership Project (3GPP) 5G and future standards. Access network 190 may further include one or more satellite networks, one or more packet switched networks, such as an IP-based network, a local area network (LAN), a wide area network (WAN), a personal area network (PAN) (e.g., a wireless PAN), a wireless local area network (WLAN), an intranet, the Internet, or another type of network that is capable of transmitting data.

In FIG. 1, the particular arrangement and number of components of environment 100 are illustrated for simplicity. In practice there may be more monitoring devices 110, application networks 120, positioning systems 170, user devices 180, and/or networks 190. For example, there may be hundreds or thousands of monitoring devices 110 and/or user devices 180.

FIG. 2 is a diagram illustrating functional components and communications of application network 120. As shown in FIG. 2, application network 120 may include a client application programming interface (API) 220, a service database 230, device-specific APIs 240, a data processing pipeline 250, an ordering platform 270, and a scheduling platform 280. Components of application network 120 may communicate directly or indirectly with monitoring devices 110 and client applications 185/browsers 188. Components of application network 120 may be implemented, for example, on physical network devices and/or virtual servers of a hosting platform.

Client API 220 may provide services for a program or an application running on user device 180 and may establish communication session with user device 180 via access network 190. For example, client API 220 may provide a web application to provide content and services related to remote equipment monitoring. According to an implementation, the web application may be served to users/user device 180 over the Internet as a single-page or multi-page application. Once users visit the web page associated with client API 220 (e.g., “https://pumpmonitor*site.com”) the application may be loaded into the browser (e.g., browser 188). When users interact with the application, the users' requests are sent to the client API 220. Client API 220 may be an API that the web application communicates with via hyper-text transfer protocol (HTTP) requests. Client API 220 may handle communication between the user (e.g., via user device 180) and the back-end services of application network 120, such as databases (e.g., service database 230), edge devices, and other infrastructure.

Client API 220 may provide support for authorizing monitoring devices 110 and/or user devices 180 to use application network 120. For example, client API 220 may store identification information for registered users and/or user devices 180. The information may be used to verify that a particular user/user device 180 has access to services and/or information provided by application network 120. Upon verifying eligibility of a user/user device 110, client API 220 may, for example, provide access to other components/devices in application network 120.

Service database 230 may include one or multiple databases that store data generated by monitoring devices 110 and/or other sources. According to an implementation, service databases 230 may be segregated for different account holders/owners. Service database 230 may act as the main source of data used by client API 220. Client API 220 may both store and retrieve data in these databases. For example, data from service database 230 may be retrieved, edited, and returned from user device 180 via client API 220. As a particular example, maintenance logs for individual pieces of equipment 105 may be stored, retrieved, and updated by authorized users of user device 180. Additionally, data processing pipeline 250 may also store data in service database 230, such as monitoring data received from monitoring devices 110 via device-specific APIs 240.

In addition to information from particular monitoring devices 110, service database 230 may also include equipment model information that may be applicable to multiple devices. For example, service database 230 may store, associated with each piece of applicable equipment 105, a description of the pump equipment, model and series information of the pump equipment, impeller trim and angle information of the pump equipment; a bill of materials (BOM) for the pump equipment; links to assembly and/or maintenance videos of the pump equipment; service and/or maintenance schedules; links to manuals regarding assembly, maintenance and/or operation of the pump equipment; or parts ordering information for the pump equipment.

Device-specific APIs 240 may be included in a network device that provides different APIs that correspond to different types of monitoring devices 110. For each monitoring device type (e.g., multi-purpose monitors, single-purpose monitors, proprietary monitors, etc.) that is supported by application network 120, a different API may handle requests to communicate with that monitoring device type. Depending on a type of monitoring device 110, device-specific APIs 250 may solicit data from a monitoring device 110 and/or receive unsolicited data (e.g., periodic data, alert/alarm data, etc.) from a monitoring device. Device-specific APIs 240 may make requests for data processing pipeline 250 to send data to service databases 230. For example, a device-specific API 240 may receive a data storage call from a monitoring device 110 (e.g., via a wireless connection and access network 190). The device-specific API 240 may ingest data from monitoring device 110 into a standardized format for use in application network 120. Standardized format may include, for example, common units of measurement, data presentation/sequence order, scale, etc., from different monitoring devices 110 on different equipment 105.

According to an implementation, device-specific API 240 may receive a list of register addresses and values, and map the addresses to attributes based on the specific monitoring device 110 and any connected control panel (e.g., associated with a monitored asset). Device-specific API 240 may interpret values that have special meaning (or non-standard) for specific control panels, such as error codes. For example, a control panel that is returning a fuel level of 112 is not saying that the fuel level is at 112%, but that there is an issue with the fuel level connection. Next, device-specific API 240 may convert the register values to default units as defined/assigned for service database 230. Then device-specific API 240 may send the standardized attribute data to service database 230 via data processing pipeline 250.

Device-specific API 240 may provide support for authorizing monitoring devices 110 on application network 120. For example, device-specific API 240 may perform a provisioning process for a monitoring device 110, including authentication, registration, and activation in application network 120.

Data processing pipeline 250 may be included in a network device that receives requests from device-specific APIs 240 and forwards data to the appropriate service database 230 for storage. For example, data processing pipeline 250 may receive request from one or more device-specific APIs 240 that contain standardized data of pump equipment 105. Data processing pipeline 250 may store the data in a database 230, such as a database associated with a particular customer.

As an example of interactions between components 220-250, assume multiple different monitoring devices 110 provide periodic data reports. Each of the monitoring devices 110 may report data in whatever units of measure it is configured to report. A first monitoring device 110 may report a temperature reading in Celsius units, and a second monitoring device 110 might report a temperature in Fahrenheit units. When each of the monitoring devices 110 reports data, device-specific API 240 converts each attribute to a default temperature unit (e.g., Fahrenheit). Device-specific API 240 provides the readings with the default temperature unit to data processing pipeline 250, which will load the standardized data to service database 230. Thus, temperature readings from the first monitoring device 110 and the second monitoring device 110 would both be stored as Fahrenheit units. When a user wants to see the data from either/both of the monitoring units 110, the user may indicate a unit preference (or have a preference associated with a stored user profile). Client API 220, for example, may convert the requested data to whatever units have been set as the preferred units. For example, if a user prefers to see temperature in Celsius units, client API 220 will convert temperature from Fahrenheit to Celsius when retrieving the data. This strategy allows for a simplified retrieval process for stored data from database 230, since each individual data sample or field does not need to be checked for unit type. The system can simply check if the user is requesting Fahrenheit or Celsius to know if conversion is needed.

Ordering platform 270 may include a network device or computing device that processes customer orders, such as orders for services and parts related to pump equipment 105. According to an implementation, client API 220 may initiate orders for parts, service, maintenance, etc., based on user input from user device 180 and/or data obtained from monitoring devices 110 (e.g., via service database 230). In one implementation, orders for maintenance and services from ordering platform 270 may be passed to scheduling platform 280 for scheduling and execution. Order platform 270 may include a web-based interface for a customer (e.g., using a user device 180) to manage (e.g., order, configure, issue commands, update, monitor, etc.) automatic orders that may be generated via client API 220. Using ordering platform 270, users may enter eligible parameters for initiating automatic service and/or parts requests. According to an implementation, ordering platform 270 may provide a structured input for users that lists possible services, bill of materials, etc., allowing users to select which services may be eligible for automated ordering and which may require separate user authorization.

Scheduling platform 280 may include a network device or computing device that schedules services and maintenance. For example, scheduling platform 280 may automatically generate service/maintenance appointments with vendors based on orders placed by ordering platform 270. According to an implementation, scheduling platform 280 may consolidate service requests for multiple equipment in the same location (e.g., within a time window). In one implementation, scheduling platform 280 may communicate with ordering platform 270 to ensure delivery of parts coincides with schedules services.

Although FIG. 2 shows exemplary components of application network 120, in other implementations, application network 120 may contain fewer, different, differently-arranged, or additional components than depicted in FIG. 2. Additionally, or alternatively, a component of application network 120 may perform one or more other tasks described as being performed by another component of application network 120.

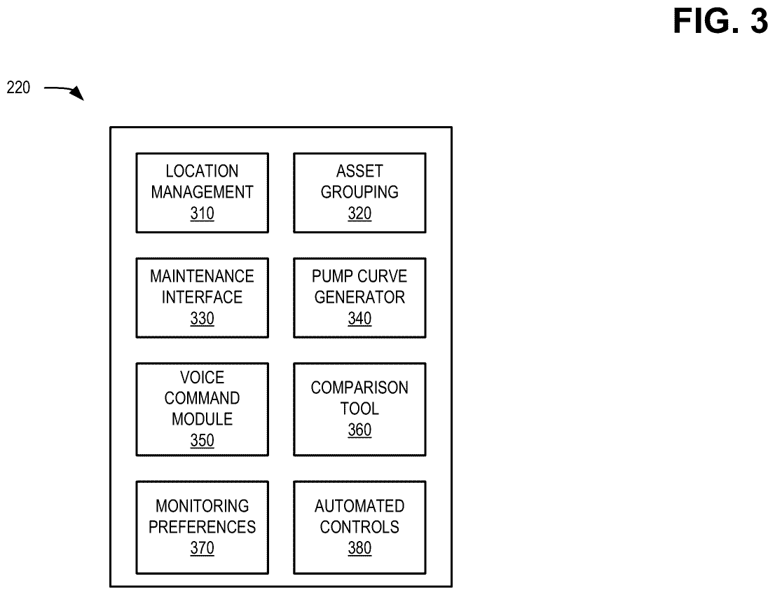

FIG. 3 is a diagram illustrating functional components of client API 220. As shown in FIG. 3, client API 220 may include a location management module 310, an asset grouping tool 320, a maintenance interface 330, a pump curve generator 340, a voice command module 350, a comparison tool 360, monitoring preferences 370, and automated controls 380.

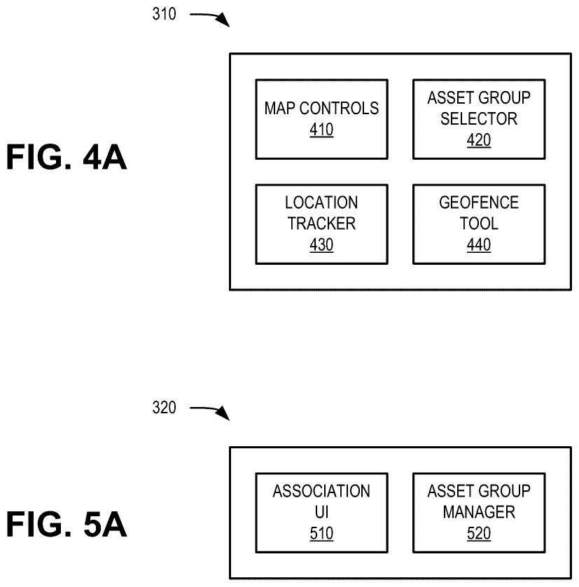

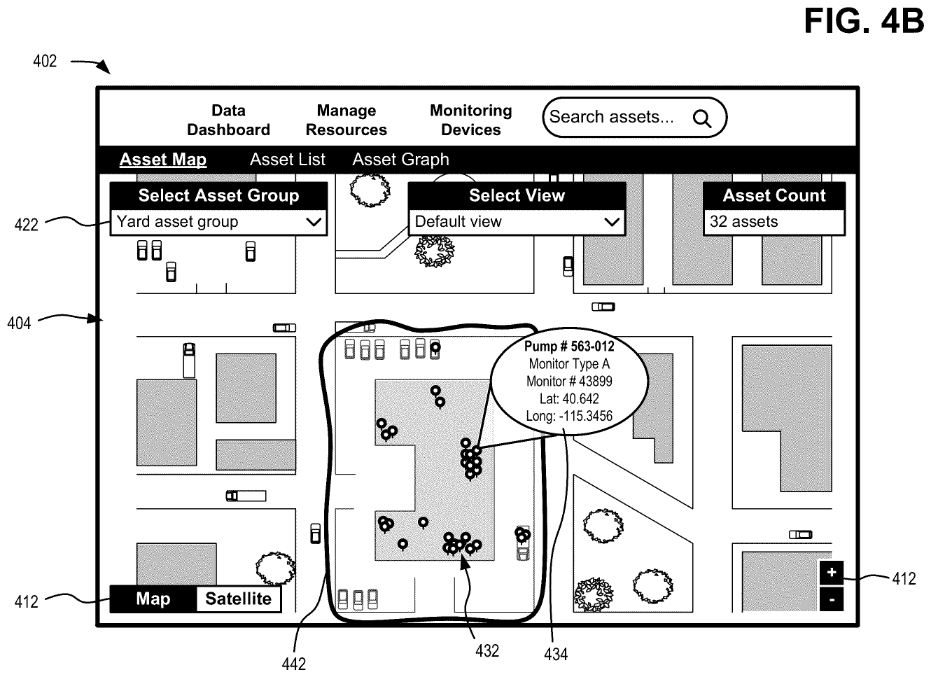

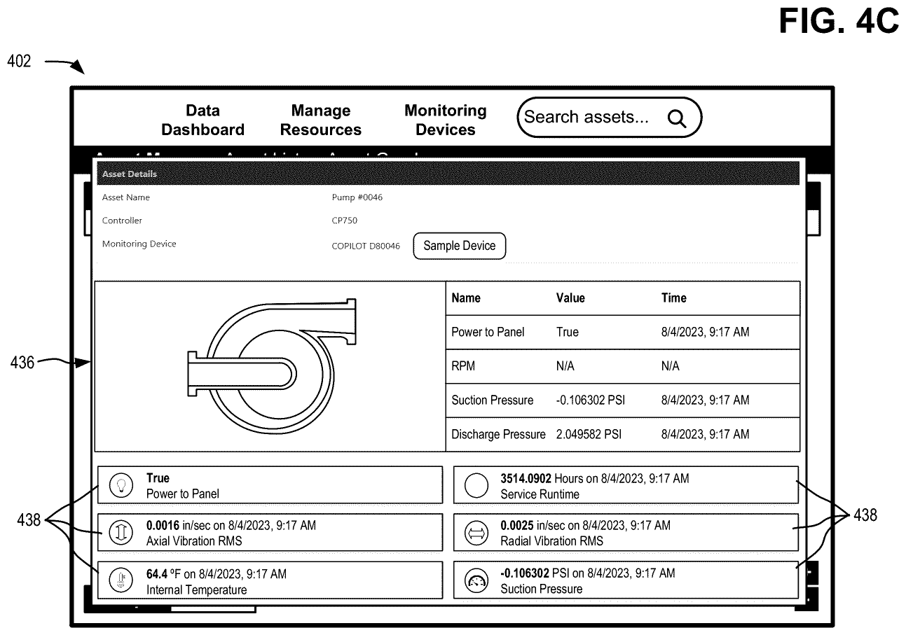

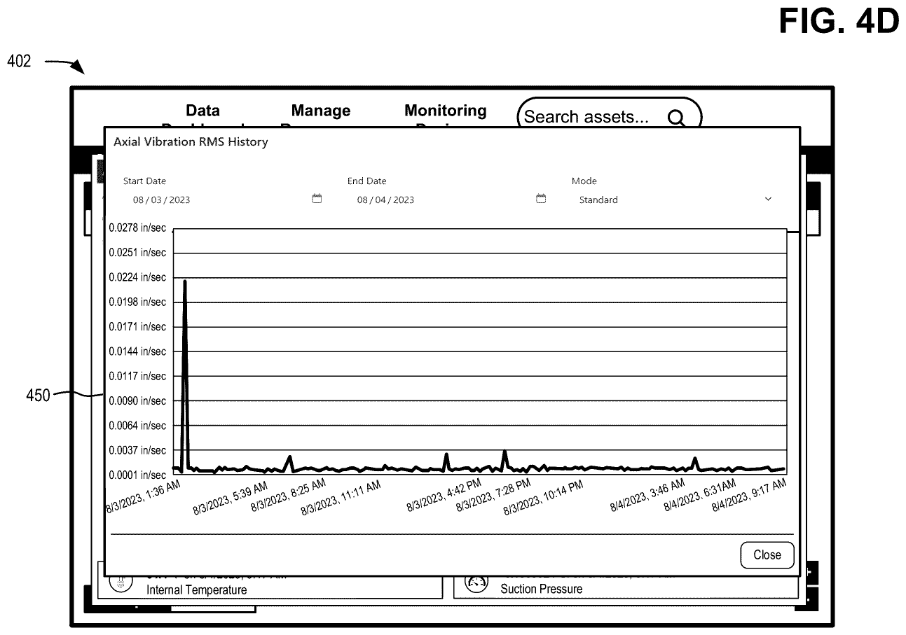

Location management module 310 may provide a user interface to enable users to group assets (e.g., monitored equipment) based on a mapped location and track assets within the group. For example, location management module 310 may permit a user to define a geofence and monitor all customer detected assets within the geofence. Monitored information may include location, along with any performance and/or maintenance indicators available from monitoring devices 110 connected to each piece of equipment 105. According to an implementation, location management module 310 may be suited for equipment rentals, where monitored assets (e.g., pumps, motors, generators, etc.) may be frequently moved within and between different locations. Location management module 310 is described further in connection with FIGS. 4A-4D.

FIG. 4A is a block diagram of logical components of location management module 310. FIG. 4B is an example screen shot illustrating functions of location management module 310. As shown in FIG. 4A, location management module 310 may include map controls 410, asset group selector 420, location tracker 430, and geofence tool 440. As shown in FIG. 4B, a user interface 402 may include a map 404 with a variety of menus and icons to accept user input, as described further herein.

Map controls 410 may control a map view and/or map orientation of map 404 to be presented to a user. For example, map controls 410 may allow a user to switch between a drawn map view and a satellite image view for a particular geographic area. As shown in FIG. 4B, user commands for map controls 410 may be input via a user map control icons 412.

Asset group selector 420 may allow a user to select one or more groups of assets for displaying/tracking. For example, asset group selector 420 may allow a user to select (e.g., from a dropdown menu, such as asset group menu 422) any asset groups associated with a user's current account. A user's account may include, for example, access to asset groups for a company (e.g., that owns or rents particular assets), multiple different companies (e.g., a rental company, an equipment service company, etc.), an individual, a municipality, or another group. As shown in FIG. 4B, user commands for asset group selector 420 may be input via asset group menu 422 (e.g., a dropdown menu). According to one implementation, all assets in the selected asset group may be displayed on map 404 as interactive asset markers 432. According to one implementation, asset group selector 420 may automatically scale (e.g., zoom in or zoom out) map 404 to allow presentation of interactive asset markers 432 for a selected asset group.

Location tracker 430 may monitor a geolocation of assets, such as equipment to which monitoring devices 110 are attached. According to an implementation, interactive asset markers 432 may be used to indicate locations of assets on map 404. Interactive asset markers 432 may show details about the asset when scrolled over with a mouse pointer. For example, mouse over details associated with an individual asset marker 432 may be provided in a pop-up window 434. A user selecting (e.g., clicking on) an asset marker 432 or pop-up window 434 may cause user interface 402 to open a separate page with more details about the asset, such as asset description page 436 shown in FIG. 4C. Asset description page 436 may include readings 438 for different asset attributes (e.g., power on/off, axial vibration, temperature, suction pressure, etc.). Selecting a reading 438 may cause user interface 402 to present historical information 450 for the selected attribute, such as selection of axial vibration data shown in FIG. 4D. In another implementation, pop-up window 434 of FIG. 4B may include a user-customizable data visualization display that adapts to a particular monitoring device configuration and/or specific customer-requested data sets (e.g., different asset attributes). In still another implementation, pop-up window 343 may superimpose key data parameters and process flows over graphical location data, for example.

Geofence tool 440 may enable a user to create location-based asset groups. For example, asset groups may be created with geofences. The geofence may define an area for which assets may be tracked (e.g., by location tracker 430) and/or indicated (e.g., via interactive asset markers 432). A user may define a geofence using user interface 402. If the selected asset group has a geofence, geofence tool 440 may show the geofence as a shape (e.g., shape 442) on map 404.

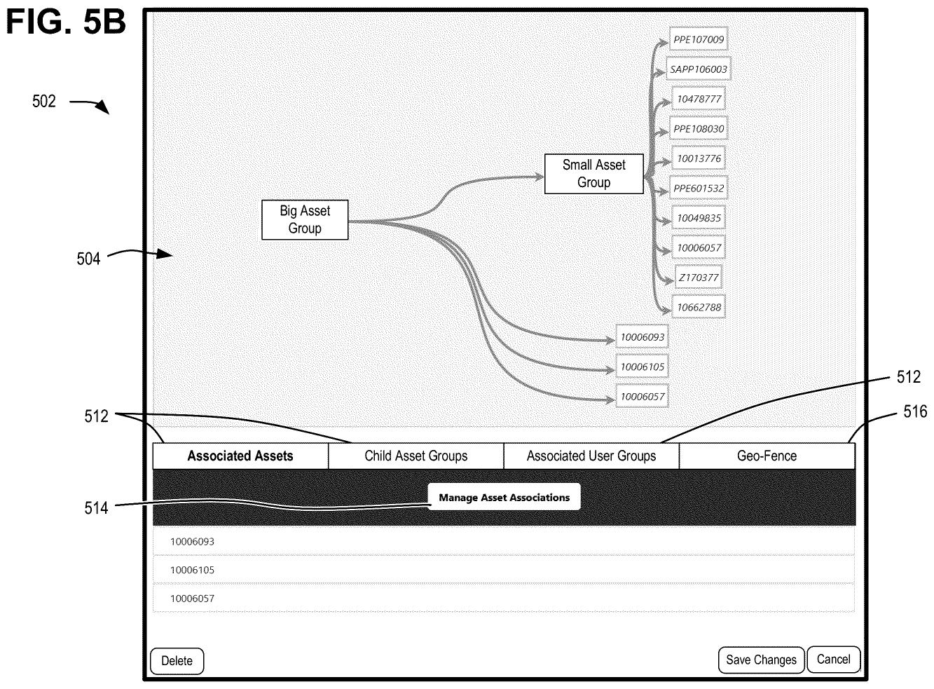

Returning to FIG. 3, asset grouping tool 320 may provide a user interface for users to define asset groups with multiple levels. For example, in one implementation, a master group (e.g., associated with a rental agency or municipality) may be associated with one or more child asset groups (e.g., associated with individual rental customers or different departments). Asset grouping tool 320 is described further in connection with FIGS. 5A and 5B.

FIG. 5A is a block diagram of logical components of asset grouping tool 320. FIG. 5B is an example screen shot illustrating functions of asset grouping tool 320. As shown in FIG. 5A, asset grouping tool 320 may include an association user interface (UI) 510 and an asset group selector 520. As shown in FIG. 5B, a user interface 502 may include a group diagram 504 and a variety of menus and icons to accept user input for defining asset groups, as described further herein.

Association user interface (UI) 510 may allow users to provide different definitions or group criteria for asset groups. Association user interface 510 may provide a visualization (e.g., diagram 504) of current asset groupings. As shown in FIG. 5B, when creating or updating an asset group, a user can select what assets to associate with the asset group by clicking the appropriate tab 512. Associating assets will cause those assets to be displayed when viewing the specific asset group (e.g., in diagram 504 and/or map 404). Assets may be assigned to asset groups, user groups, and/or location-based groups. Associating assets with a group will give the current asset group access to all assets inside of that asset group. Associating users will also allow only the selected users to be able to view the asset group and, by extension, the assets. In one implementation, a user may be associated with contact information (e.g., email, text, in-application identifier, social media link, etc.) to receive automatic updates or notifications for tracked events associated with assets in an asset group.

According to an implementation, an administrator (e.g., a user) may assign groups as part of an initial asset assignment (e.g., purchase, rental, etc.). For example, selecting an association button 514 will give the user/administrator the ability to associate resources related to the selected tab 512 (asset/asset group/user group) with the current asset group. Association diagram 504 show the relationship of the related assets based on the currently selected tab 512. In one implementation, as shown in FIG. 5B, relationships include the current asset group shown on the left side.

Geofence tab 516 may be used to create location-based asset groups. For example, geofence tab 516 may allow users to create a geofence for the current asset group by plotting an area (e.g., corresponding to shape 442) on map 404. According to one implementation, if an asset in the asset group is moved outside the geofence, client API 220 may send a notification (e.g., an email, text message, in-application notification, etc.) to all users associated with the asset group.

Asset group manager 520 may store and update user access rights and roles for asset groups. For example, asset groups defined using association user interface 510 may be associated with different users and different access levels, such as access to view, access to change, etc.

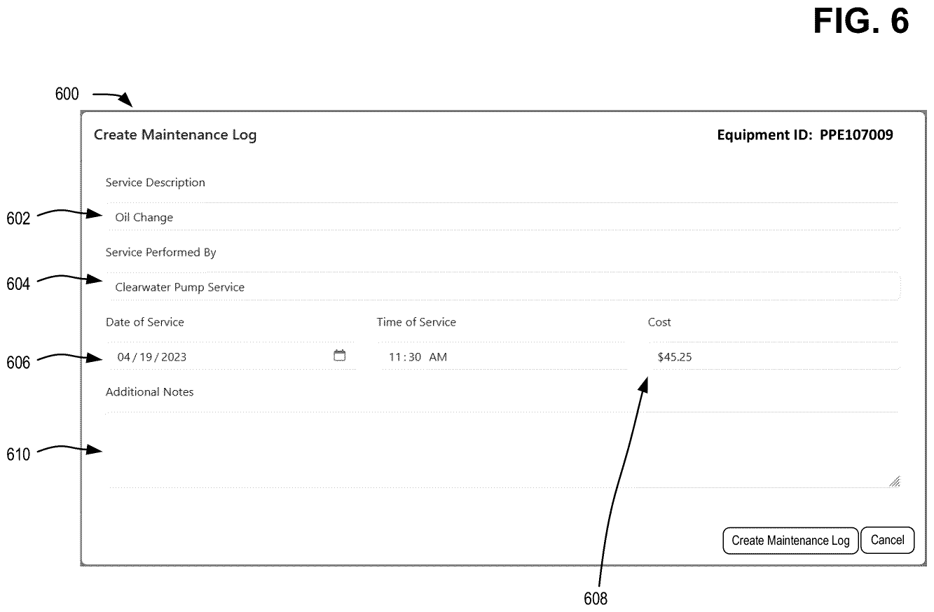

Returning again to FIG. 3, maintenance interface 330 may permit users to generate maintenance logs and service records for equipment 105 associated with a monitoring device 110. For example, a user may create any number of maintenance logs for assets in their account. FIG. 6 is an example screen shot illustrating a user interface 600 provided via maintenance interface 330. User interface 600 for maintenance logs may include a service description field 602, a service provider field 604, date/time of service fields 606, a cost field 608, and a notes field 610. According to an implementation, one or more of fields 602-610 may include structured input (e.g., menu items, standardized text selections, etc.).

Service description field 602 may include a type of service performed on equipment 105. Service provider field 604 may include information about who performed the service in service description field 602. Date/time of service fields 606 may include a calendar and/or time entry associated with service description field 602. Cost field 608 may include a cost (e.g., invoiced cost, estimated cost, etc.) associated with service description field 602. Notes field 610 may include optional additional information related to service description field 602.

Returning to FIG. 3, maintenance interface 330 may also be used to generate maintenance suggestions based on data from monitoring device 170 and service history from maintenance logs/service records. In one implementation, maintenance suggestions may be based on service hours, calendar days, types of operation (e.g., high vibration, high speed), and/or other historical data. Similarly, maintenance interface 330 may be used to generate part replacement suggestions based on data from monitoring device 170 and service histories. Maintenance suggestions and/or part replacement suggestions may be presented as notifications (e.g., a text message, an email, an in-application message, etc.) to a user associated with the asset group on user device 180.

Pump curve generator 340 may provide real-time pump curve calculations for equipment 105 based on data in service database 230. For example, a user may select an interactive asset marker 432 from map 404 or a particular pump identifier from diagram 504 to obtain detailed pump information. Based on the user selection, client API 220 may access service database 230 and retrieve data for the selected pump. Using the retrieved data, pump curve generator 340 may present and display a pump curve (e.g., a graph of the overall performance capabilities of a pump) for the operation of a selected equipment 105. For example, pump curve generator 340 may indicate where, in relation to the pump curve, a particular pump is currently operating. In addition, pump curve generator 340 may provide additional pump-related data such as a description of the pump equipment, model and series information of the pump equipment, impeller trim and angle information of the pump equipment, a bill of materials (BOM) for the pump equipment, links to assembly and/or maintenance videos of the pump equipment, links to manuals regarding assembly, maintenance and/or operation of the pump equipment, or parts ordering information for the pump equipment. In another implementation, pump curve generator 340 may interface with comparison tool 360, described further below, to provide a graphical comparison of performance data from a selected pump against defined benchmarks (e.g., customer-defined benchmarks, OEM benchmarks, etc.).

Voice command module 350 may interpret and accept voice commands from users. According to an implementation, user device 180/client application 185/browser 188 may be configured to receive user input in the form of a voice command. For example, user device 180 may be equipped with a microphone to accept user input that may be forwarded to voice command module 350. Examples of voice commands may include “Show me which pumps in my fleet need fuel,” “Show me which pumps are on/off,” “Show me which pumps are part of a fleet of rental pumps,” and “Show me which pumps are currently exceeding alert thresholds.” Voice command module 350 may associate each known voice command with a corresponding API call, for example. Each of the API calls may direct data retrieval from service database 230 to support the requested voice command.

Comparison tool 360 provides a user interface that allows for simultaneously viewing operational data of multiple pieces of equipment 105. Comparison tool 360 may retrieve from database 230 data that is standardized by device-specific APIs 240. In one implementation, a user (e.g., using user device 180) may select individual pieces of equipment that are being monitored by different monitoring devices 110. Comparison tool 360 may provide a side-by-side presentation of data from two or more monitoring devices to permit a comparison. According to another implementation, comparison tool 360 may also enable analysis on the selected assets. For example, a user may ask for the difference between asset A and asset B. Assuming asset A and asset B both have the same part number and in the same application, common data fields can be compared. Thus, if a vibration level for asset A is 0.20 inches/second (5 mm/s) and asset B is 0.40 in/s (10 mm/s), comparison tool 360 would show that asset B is vibrating 50% more, which could indicate an upset system condition or an approaching failure event. Similar comparisons may be provided for with pressure, flow rate, and/or temperature data fields.

Monitoring preferences 370 may allow users to input thresholds and/or settings for monitoring pump equipment. For example, user-defined conditions (e.g., selected run time, high temperature, vibration level, etc.) may be link to alert thresholds. In one implementation, monitoring preferences 370 may trigger highlighting of specific assets (e.g., interactive asset markers 432) on a map (e.g., map 404) based on comparison of monitoring device data to user-defined conditions. In still another implementation, monitoring preferences 370 may provide to users an alert threshold suggestion based on operating history of a specific pump or a type of pump. For example, monitoring preferences 370 may provide a recommended vibration alert threshold or temperature alert threshold based on pump operations in a similar environment.

Automated controls 380 may allow a user to configure automated actions for assets in an asset group. For example, automated controls 380 may allow a user to control equipment connected to one monitoring device 170 based on conditional logic driven by data from another monitoring device 170. As a specific example, automated controls 380 may be programmed with conditional logic such that, if a certain threshold of one monitored asset (i.e., pump equipment 105) in an asset group indicates a catastrophic failure, automated controls 380 may signal other assets to automatically shut down.

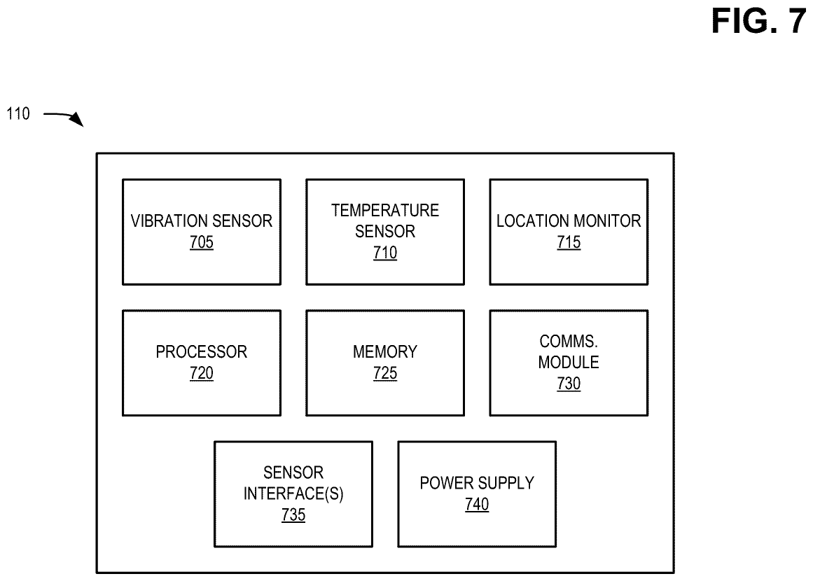

FIG. 7 is a block diagram of internal components of monitoring device 110, according to an implementation. As shown in FIG. 7, monitoring device 110 may include a vibration sensor 705, a temperature sensor 710, a location monitor 715, a processor 720, a memory 725, a communications module 730, sensor interfaces 735, and a power supply 740. The internal components may be enclosed, for example, within a housing (not illustrated) that is configured for attachment to a portion of pump equipment 105. According to an implementation, one or more components of monitoring device 110 may be installed on a printed circuit board, an etched wiring board, or a printed circuit assembly.

Vibration sensor 705 may include accelerometers, signal amplifiers, and filters to detect and indicate sensed vibration in different directions. For example, vibration sensors 705 may include a set of three accelerometers to measure vibration along three respective axes. In another implementation, vibration sensors 705 may measure vibration along one or two axes. According to one embodiment, the accelerometer may output a voltage or current proportional to the acceleration.

Temperature sensor 710 may include a sensor to detect a temperature, for example, within the housing of monitoring device 110, which may generally correspond to a temperature of a bearing housing of pump equipment 105. For example, changes in the bearing housing temperature will typically cause proportional temperature changes in monitoring device 110. In one implementation, temperature sensor 710 may output an analog voltage value to processor 720 as a voltage output representing temperature (e.g., in degrees Fahrenheit or Celsius).

Location monitor 715 may communicate with positioning system 170 to detect a location of monitoring device 110. For example, location monitor 715 may include a location identification system (e.g., global positioning system (GPS) or another assisted location determining system).

Processor 720 may include one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 720 may be implemented as hardware (e.g., a microprocessor, etc.) or a combination of hardware and software (e.g., a SoC, an ASIC, etc.) and may include one or multiple memories (e.g., memory 725, cache, etc.).

Processor 720 may control the overall operation, or a portion of operation(s), performed by monitoring device 110. Processor 720 may collect sample readings from vibration sensor 705, temperature sensor 710, location monitor 715, sensors connected to sensor interfaces 735, and/or power supply 740. Processor 720 may cause sample data to be sent to application network 120 on a periodic basis. In some implementations, processor 720 may also be programmed to detect if readings from any sensors exceed a predetermined threshold value and generate an alert signal when a threshold is exceeded.

Memory 725 may include one or multiple memories and/or one or multiple other types of storage mediums. For example, memory 725 may include random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Alternatively, or additionally, memory 725 may include a Micro-Electromechanical System (MEMS)-based storage medium, and/or a nanotechnology-based storage medium. Memory 725 may store data (e.g., from vibration sensor 705, temperature sensor 710, location monitor 715, sensors connected to sensor/Modbus interfaces 735, power supply 740, etc.), software, and/or instructions related to the operation of monitoring device 110.

Communications module 730 may permit monitoring device 110 to communicate with other devices, networks, systems, devices, and/or the like. According to some implementations, communications module 730 includes multiple wireless interfaces. For example, communications module 730 may include multiple transmitters and receivers, or transceivers. Communications module 730 may include one or more antennas. For example, communications module 730 may include an array of antennas. Communications module 730 may operate according to one or more communication standards, such as a cellular network standard (e.g., 4G, 5G, etc.), a local wireless network standard (e.g., Wi-Fi), or a personal wireless network standard (e.g., Bluetooth). Communications module 730 may include various processing logic or circuitry (e.g., multiplexing/de-multiplexing, filtering, amplifying, converting, error correction, etc.).

Sensor interface 735 may include one or more interfaces to receive (e.g., via wired connections) analog or digital data from sensors and/or Modbus-enabled devices that are external to monitoring device 110. For example, sensor interface 735 may include interfaces to accept hard-wired inputs from pump pressure sensors, flow sensors, rotation speed sensors, etc. According to an implementation, multiple sensor interfaces 735 (e.g., 2, 3, 8, etc.) may be used with monitoring device 110. According to another implementation, sensor interface 735 may include a Modbus interface to enable monitoring device 110 to act as a Modbus master for other Modbus-enabled devices. For example, a Modbus connection may be used to allow monitoring device to receive and upload data from an engine (e.g., pump driver) associated with pump equipment 105.

Power supply 740 may include one or more batteries (e.g., a rechargeable battery, a replaceable battery, etc.) or external power sources to power other components of monitoring device 110. Power supply 740 may include, for example, a conventional consumer-sized battery (e.g., size AA, 9-volt, etc.) or a rechargeable battery. In one implementation, internal power supply 740 may include a voltage monitor to measure a battery level (e.g., voltage of a battery).

Although FIG. 7 shows exemplary components of monitoring device 110, in other implementations, monitoring device 110 may contain fewer, different, or additional components than depicted in FIG. 7. For example, some monitoring devices 110 may not include a sensor interface 735. Additionally, similar components of one monitoring device 110 may include one or multiple types that may generate data in different formats.

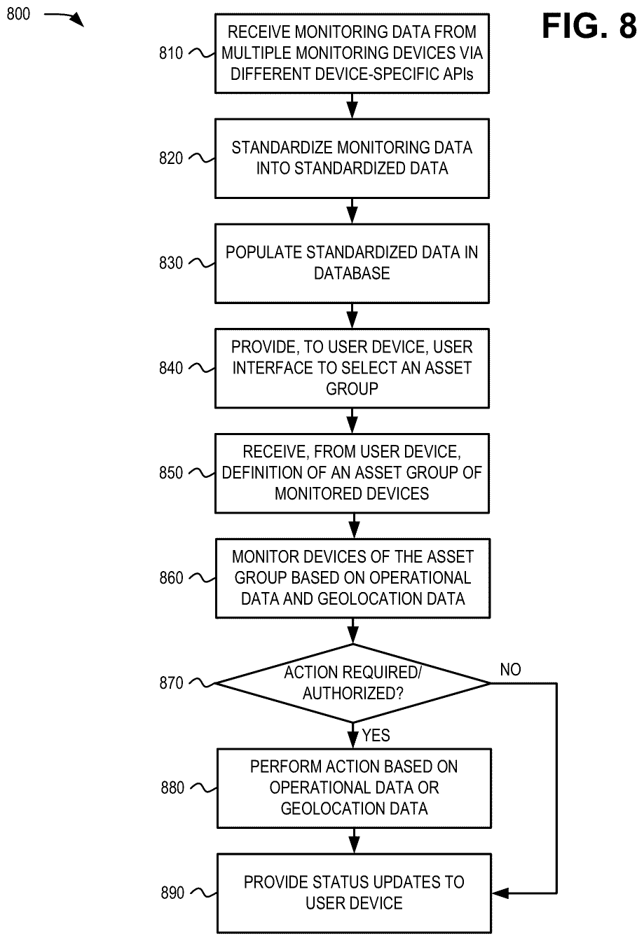

FIG. 8 is a flow diagram of a process 800 for an equipment monitoring and management system. In one implementation, process 800 may be performed by one or more devices in application network 120, such as devices executing client API 220.

Process 800 may include receiving monitoring data from multiple monitoring devices via different device-specific APIs (block 810) and performing data transformations to standardize the monitoring data into standardized data (block 820). For example, each monitoring device 110 may be configured with a uniform resource locator (URL), IP address, or another resource locator to enable monitoring devices 110 to send information to a network device executing a device-specific API 240. Once activated on a cellular network (e.g., access network 190), monitoring device 110 may establish communications with the appropriate device-specific API 240 in application network 120. Each API 240 may receive data from one or more of monitoring devices 110 and perform data transformations to convert data from each monitoring device 110 into a standardized format.

Process 800 may further include populating the standardized data in a database (block 830) and providing, to a user device, a user interface to select an asset group (block 840). For example, data processing pipeline 250 may receive a request from one or more device-specific APIs 240 that includes standardized data of pump equipment 105 obtained by a monitoring device 110. Data processing pipeline 250 may store the data in database 230. At some later point in time, a user of user device 180 may access client API 220, which may provide a web page (e.g., for browser 188) or application (e.g., application 185) to enable a user to access user interfaces 402, 502, etc.

Process 800 may also include receiving, from the user device, a definition of an asset group of monitored devices (block 850). For example, using user interface 502, a user may identify an asset group. In one implementation, an asset group may be defined based on a geographic area defined by a user of user device 180. In another implementation, as asset group may be defined based on common associations (e.g., renter, ownership, department, company, etc.).

Process 800 may additionally include monitoring devices of the asset group based on the operational data and geolocation data (block 860) and determining if an action is required and authorized based on the status update (block 870). For example, based on instructions from a user device 180, client API 220 may monitor data in database 230. Client API 220 may detect that a particular data update triggers a previously-authorized automated action. As an example, a user associated with the asset group may authorize automated scheduling of periodic maintenance for equipment 105 based on operational service intervals. Client API 220 may detect that the number of operating hours for a service interval has been reached (or is approaching).

If an action is required and authorized (block 870—Yes), process 800 may include performing an action based on the operational data or geolocation data (block 880). For example, if client API 220 is authorized to perform automated actions, client API 220 may use ordering platform 270 and/or scheduling platform 280 to order replacement parts and request scheduled maintenance for pump equipment 105.

If no action is required or authorized (block 870—No) or after process block 880, process 800 may include providing status updates to the user device (block 890). For equipment 105 in an asset group, monitoring may include, for example, confirming operating conditions are within expected thresholds, tracking periodic maintenance/service intervals, and location tracking. When client API 220 detects a threshold (e.g., location boundary, operating threshold, maintenance window, etc.) for a monitored category is reached, client API 220 may provide a notification (e.g., a text message, an email, an in-application message, etc.) to a user associated with the asset group. The alert message may include, for example, an indication that an automated ordering process has been initiated or a request for authorization to initiate an order. Depending on the type of notification the alert message may also include ordering information, a part type, a service contact, a recommended scheduling window, etc.

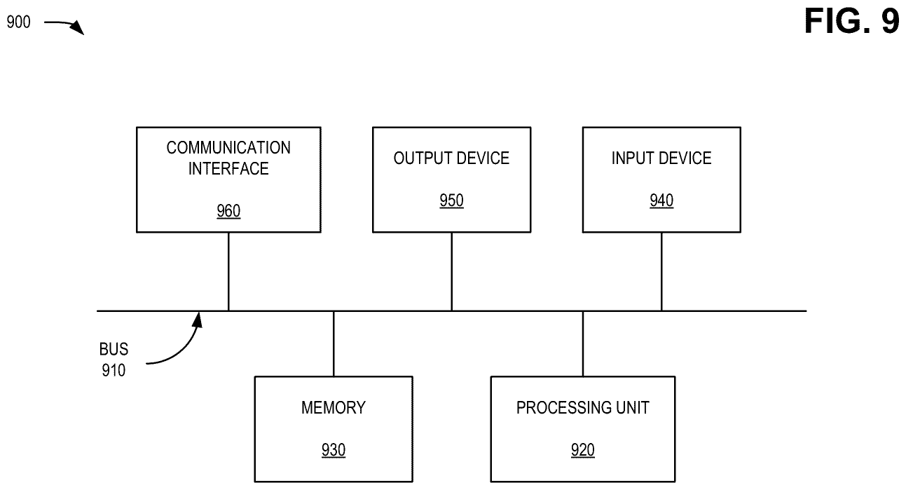

FIG. 9 is a diagram of exemplary components of a device 900 that may correspond to ordering platform 270, scheduling platform 280, user device 180, monitoring device 110, or network devices executing client API 220, service database 230, device-specific API 240, or data processing pipeline 250. As shown in FIG. 9, device 900 may include a bus 910, a processing unit 920, a memory 930, an input device 940, an output device 950, and a communication interface 960.

Bus 910 may permit communication among the components of device 900. Processing unit 920 may include one or more processors or microprocessors that interpret and execute instructions. In other implementations, processing unit 920 may be implemented as or include one or more application specific integrated circuits (ASICs), field programmable gate arrays (FPGAs), or the like.

Memory 930 may include a random access memory (RAM) or another type of dynamic storage device that stores information and instructions for execution by processing unit 920, a read only memory (ROM) or another type of static storage device that stores static information and instructions for the processing unit 920, and/or some other type of magnetic or optical recording medium and its corresponding drive for storing information and/or instructions.

Input device 940 may include a device that permits an operator to input information to device 900, such as a keyboard, a keypad, a mouse, a pen, a microphone, one or more biometric mechanisms, and the like. Output device 950 may include a device that outputs information to the operator, such as a display, a speaker, etc.

Communication interface 960 may include a transceiver, such as a radio frequency transceiver, that enables device 900 to communicate with other devices and/or systems. For example, communication interface 960 may include mechanisms for communicating with other devices, such as other computing devices. Each of such other devices may include its respective communication interface 960 to achieve such communication.

As described herein, device 900 may perform certain operations in response to processing unit 920 executing software instructions contained in a computer-readable medium, such as memory 930. A computer-readable medium may include a tangible, non-transitory memory device. A memory device may include space within a single physical memory device or spread across multiple physical memory devices. The software instructions may be read into memory 930 from another computer-readable medium or from another device via communication interface 960. The software instructions contained in memory 930 may cause processing unit 920 to perform processes described herein. Alternatively, hardwired circuitry may be used in place of or in combination with software instructions to implement processes described herein. Thus, implementations described herein are not limited to any specific combination of hardware circuitry and software.

Although FIG. 9 shows exemplary components of device 900, in other implementations, device 900 may contain fewer, different, differently-arranged, or additional components than depicted in FIG. 9. In still other implementations, a component of device 900 may perform one or more other tasks described as being performed by another component of device 900.

A device, systems, and methods are provided for remotely monitoring and managing pump equipment. An end-to-end solution is provided to connect pumps, pump-related assets, and end-users into a combined monitoring and management system. In contrast, current monitoring methods involve disjointed systems and software that require multiple logins and are difficult to link together.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. Also, while a series of blocks have been described with regard to FIG. 8 the order of the blocks and message/operation flows may be modified in other embodiments. Further, non-dependent blocks may be performed in parallel. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Certain features described above may be implemented as “logic” or a “module” that performs one or more functions. This logic or module may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such.

What is claimed is:

1. A system comprising:
one or more monitoring devices configured to provide operational data and geolocation data of monitored equipment; and
a network device configured to:
receive monitoring data, from the monitoring devices, via different device-specific application programming interfaces (APIs),
perform a data transformation to standardize the monitoring data into standardized data,
store the standardized data in a database,
provide, to a user device, a user interface to select a group of the monitored equipment,
receive, from the user device via the user interface, a definition of the group,
monitor the monitored equipment of the group based on the operational data and geolocation data, and
provide a status update to the user device based on the monitoring.

2. The system of claim 1, wherein the network device is further configured to:
perform an action based on at least one of the operational data or the geolocation data.

3. The system of claim 1, wherein the network device is further configured to:
identify an action to be performed based on the operational data or the geolocation data,
confirm authorization to perform the action, and
automatically initiate performance of the action.

4. The system of claim 1, wherein the network device is further configured to:
provide, to the user device, a side-by-side comparison of operational data from two of the one or more monitoring devices.

5. The system of claim 1, wherein the user interface to select the group includes a map on which to define a geofence and a user tool to define a geofence boundary, and
wherein the definition of the group includes the monitoring devices within geofence boundary.

6. The system of claim 5, wherein, when monitoring the monitored equipment of the group, the network device is further configured to:
identify when monitored equipment of the group moves outside the geofence boundary.

7. The system of claim 1, wherein, when monitoring the monitored equipment of the group, the network device is further configured to:
identify when monitored equipment of the group achieves an operational parameter that exceeds a threshold.

8. The system of claim 1, wherein, when monitoring the monitored equipment of the group, the network device is further configured to:
identify when monitored equipment of the group reaches a maintenance threshold for in-service hours.

9. The system of claim 1, wherein the network device is further configured to:
store, in the database, operating thresholds and maintenance schedules for different equipment models of the group, and
associate each of the monitored equipment of the group with the operating thresholds and maintenance schedules of one of the different equipment models.

10. The system of claim 1, wherein the operational data includes vibration data and temperature data for the monitored equipment.

11. A method performed by a network device, comprising:
establishing a wireless connection with monitoring devices configured to collect operational data and geolocation data of monitored equipment;
receiving, from the monitoring devices, monitoring data via device-specific APIs;
performing a data transformation to standardize the monitoring data into standardized data;
storing the standardized data in a database;
providing, to a user device, a user interface to select an asset group of the monitored equipment;
receiving, from the user device via the user interface, information selecting the asset group;
monitoring the monitored equipment of the asset group based on the operational data and geolocation data; and
providing a status update to the user device based on the monitoring.

12. The method of claim 11, further comprising:
performing an action based on the operational data or the geolocation data.

13. The method of claim 11, further comprising:
identifying an action to be performed based on the operational data or the geolocation data;
confirming authorization to perform the action; and
automatically initiating performance of the action.

14. The method of claim 11, further comprising:
providing, to the user device, a comparison of operational data from two of the monitoring devices.

15. The method of claim 11, wherein the user interface to select the asset group includes a map on which to define a geofence and a user tool to define a geofence boundary, and wherein receiving the information selecting the asset group comprises:
receiving, via the user interface, the information selecting the asset group based on the geofence boundary.

16. The method of claim 11, wherein, monitoring the monitored equipment of the asset group, further comprises:
identifying when any monitored equipment of the asset group achieves an operational parameter that exceeds a threshold.

17. The method of claim 11, further comprising:
store, in the database, operating thresholds and maintenance schedules for different equipment models of the asset group, and
associate each of the monitored equipment of the asset group with the operating thresholds and maintenance schedules of one of the different equipment models.

18. A non-transitory computer-readable medium containing instructions executable by at least one processor of a network device, the non-transitory computer-readable medium comprising one or more instructions for:
establishing a wireless connection with monitoring devices configured to collect operational data and geolocation data of monitored equipment;
receiving, from the monitoring devices, monitoring data via device-specific APIs;
performing a data transformation to standardize the monitoring data into standardized data;
populating the standardized data in a database;
providing, to a user device, a user interface to select a group of the monitored equipment;
receiving, from the user device via the user interface, a definition of the asset group;
monitoring the monitored equipment of the group based on the operational data and geolocation data; and
providing information to the user device based on the monitoring.

19. The non-transitory computer-readable medium of claim 18, further comprising instructions for:
storing, in the database, operating thresholds and maintenance schedules for different equipment models of the group;
associating each of the monitored equipment of the group with the operating thresholds and maintenance schedules of one of the different equipment models,
wherein, the instructions for monitoring the monitored equipment further include:
identifying when any monitored equipment of the group achieves an operational parameter that exceeds a corresponding operating threshold, or
identifying when any monitored equipment of the group reaches a service hour threshold a corresponding maintenance schedule.

20. The non-transitory computer-readable medium of claim 18, wherein when performing the data transformation, the network device is configured to:
interpret values, in the monitoring data, that have non-standard meaning for specific control panels associated with a monitored device, and
convert the register values to default units assigned for the database.
